(19) United States
(12) Patent Application Publication
(10) Pub. No.: US 2025/0311745 A1
(43) Pub. Date: Oct. 9, 2025

(54) BLOOM-RETARDING ADDITIVE

(71) Applicant: AAK AB (PUBL), Malmo (SE)

(72) Inventors: Bjarne JUUL, Malmo (SE); Jeppe Lindegaard HJORTH, Malmo (SE)

(21) Appl. No.: 18/869,431

(22) PCT Filed: May 31, 2023
(86) PCT No.: PCT/SE2023/050540

§ 371 Date: Nov. 26, 2024

(30) Foreign Application Priority Data
May 31, 2022 (SE) 2230172-5

(51) Int. Cl. A23G 1/36; A23D 9/04

(52) U.S. Cl. CPC A23G 1/36; A23D 9/04

(57) ABSTRACT

The present invention relates to the field of chocolate and chocolate-like products. More specifically, the present invention relates to additives for chocolate and chocolate-like products, and in particular an additive that is derived from vegetable fats such as cocoa butter equivalents. The additive enhances the shelf-life of chocolate and chocolate-like products by delaying the onset of bloom.

### FIELD

The present invention relates to the field of chocolate and chocolate-like products. More specifically, the present invention relates to additives for chocolate and chocolate-like products, and in particular an additive that is derived from vegetable fats such as cocoa butter equivalents. The additive enhances the shelf-life of chocolate and chocolate-like products by delaying the onset of bloom.

### BACKGROUND

Across the world, chocolate is regarded as being one of the finest types of confectionary, and various types and shapes of chocolate have been developed over the years. Innovation within the field of chocolate has largely focused on sensory aspects, such as the taste and mouthfeel of chocolate. The visual appearance of a chocolate is, however, also important for a consumer's overall perception of quality.

One of the key issues relating to the visual appearance of chocolate is the formation of bloom. Bloom is an easily recognisable phenomenon that occurs in chocolate thereby rendering its surface dull and slightly white. Bloom can occur at any time, but typically takes place after weeks or months of storage.

One of the causes of bloom is changes in the crystal form of the fats, such as cocoa butter, in a chocolate product. Cocoa butter can exist in a number of different polymorphic crystal forms. The most desirable form of cocoa butter is Form V as this imparts a desirable glossy appearance and appealing snap to chocolate. In order to obtain a chocolate product in which cocoa butter in present predominantly in Form V, the chocolate ingredients are mixed and then tempered. During the tempering process, chocolate is heated and slowly cooled to encourage the formation of Form V crystals of cocoa butter.

Unfortunately, Form VI rather than Form V is the most stable polymorphic form of cocoa butter. Thus, over time and particularly when particularly when stored somewhere warm or fluctuating in temperature, Form V can undergo polymorphic transition into Form VI. It is this change in crystal form that can lead to the appearance of bloom on the surface of chocolate.

Poor tempering of chocolate, in which Form IV is formed rather than Form V, can accelerate the onset of bloom. However, even well-tempered chocolate will bloom when stored for long periods and/or in unfavourable conditions. As such, various methods for avoiding the formation of bloom in chocolate have been proposed. One of these methods is the use of bloom-retarding components.

Bloom-retarding components that have been used in the past include high-melting milk fat fractions, sorbitan tristearate, and triglyceride compositions which are used as a substitute for at least some of the cocoa butter in chocolate. Triglyceride compositions may be obtained by chemical interesterification of vegetable fats in the presence of particular catalysts.

An alternative triglyceride composition is disclosed in WO 2014/071955. This document discloses a process for preparing a bloom-retarding component for chocolate and chocolate-like products. The process comprises deodorising a triglyceride composition comprising at least 40% by weight of monounsaturated symmetric triglycerides for at least 60 minutes at a temperature of at least 220° C. Although the bloom-retarding component that is prepared in WO 2014/071955 is shown to be very effective at enhancing the visually-acceptable shelf-life of chocolate and chocolate-like products, it unfortunately impacts the viscosity—and therefore handling—of the chocolate during processing. Thus, the composition of the chocolate and/or processing conditions may have to modified to take account of the viscosifying effect of the bloom-retarding additive.

Another alternative triglyceride composition is disclosed in WO 2020/236076. This document also discloses a process for preparing a bloom-retarding component for chocolate and chocolate-like products. The process comprises deodorising a triglyceride composition comprising 40 to 95% by weight of monounsaturated symmetric triglycerides for at least 60 minutes at a temperature of at least 220° C.

Although the bloom-retarding components that is prepared in WO 2014/071955 and WO 2020/236076 are shown to be very effective at enhancing the visually-acceptable shelf-life of chocolate and chocolate-like products, it unfortunately impacts the viscosity—and therefore handling—of the chocolate during processing. Thus, the composition of the chocolate and/or processing conditions may have to be modified to take account of the viscosifying effect of the bloom-retarding additive.

Accordingly, there remains a need for bloom-retarding additives for chocolate and chocolate-like products. In particular, there remains a need for additives which increase the time period over which the product remains visually appealing to consumers, but which does not affect the processability of the product.

### SUMMARY

It has surprisingly been found that a highly effective bloom-retarding additive, which does not significantly viscosify a chocolate or chocolate-product in which it is used, may be prepared by a method in which a mixture of a vegetable fat composition and free fatty acids, at least some of which are unsaturated, is maintained at an elevated temperature for a significant period of time. Lower viscosity is beneficial in many areas of chocolate production since it makes a chocolate or chocolate-like product easier to handle in production, easier to distribute in moulds and easier to use as coating. Without wishing to be bound by theory, it is believed that a ratio by weight of SatSatO to Sat₃≥1.5, preferably >1.6, and more preferably >1.7, at least in part, is responsible for the beneficial properties of the additive that is produced in the reaction.

Accordingly, in one aspect, the present invention provides a bloom-retarding additive for use in a chocolate or a chocolate-like product, wherein the additive is a modified vegetable fat which comprises:
SatOSat in an amount of at least 55% by weight,
SatSatO in an amount of at least 2.8% by weight, and
a ratio by weight of SatSatO to Sat₃≥1.5, preferably >1.6, and more preferably >1.7.

Also provided is a method for preparing a bloom-retarding additive for a chocolate or chocolate-like product, said method comprising:
a) providing a reaction mixture which comprises a vegetable fat composition and free fatty acids, wherein at least some of the free fatty acids are unsaturated; and
b) forming the additive by heating the reaction mixture to a temperature of at least 190° C. and maintaining the temperature for a period of at least 4 hours

In a further aspect, an ingredient for a chocolate an ingredient for a chocolate or chocolate-like product is provided which comprises a bloom-retarding additive of the present invention and cocoa butter and/or a cocoa butter equivalent, as well as a method of preparing an ingredient for a chocolate or chocolate-like product which comprises blending the bloom-retarding additive of the present invention with cocoa butter and/or a cocoa butter equivalent.

Also provided is a chocolate or chocolate-like product which comprises a bloom-retarding additive or an ingredient for a chocolate or chocolate-like product of the present invention and one or more further edible ingredients, as well as a method of preparing a chocolate or chocolate-like product which comprises blending a bloom-retarding additive or an ingredient for a chocolate or chocolate-like product of the present invention with one or more further edible ingredients.

Bloom-retarding additives, ingredients for a chocolate or chocolate product, and chocolate or chocolate-like products, which are obtainable by a method of the present invention are further provided.

In another aspect, the invention provides for various uses of a bloom-retarding additive or ingredient for a chocolate or chocolate-like product of the present invention. For instance, use of the bloom-retarding additive or the ingredient in a chocolate or chocolate-like product is provided. Also provided is the use of the bloom-retarding additive or the ingredient as a bloom-retarding component in a chocolate or chocolate-like product. Further provided is the use of the bloom-retarding additive or the ingredient for retarding bloom while maintaining the processability of a chocolate or chocolate-like product. Use of the bloom-retarding additive in cocoa butter or a cocoa butter equivalent is also provided. Finally provided is the use of the bloom-retarding additive for enhancing the bloom-retarding properties of cocoa butter or a cocoa butter equivalent.

The aspects of the inventions are described in further detail below.

### DETAILED DESCRIPTION

### Definitions

The following definitions apply throughout this specification, and for the interpretation of the claims.

“Sat” is used to denote any saturated fatty acid, and “U” is used to denote any unsaturated fatty acid. “P” is used to denote palmityl, “O” is used to denote oleyl, and “S” is used to denote stearyl.

“X₃” is used to denote the sum of any triglyceride comprising three of the fatty acid “X”. “X₂Y” is used to denote the sum of any triglyceride comprising two of the fatty acid “X” and one of the fatty acid Y in any stereoisomeric form. The amounts, in % by weight, of non-stereospecific triglycerides, such as X₃ and X₂Y, that are present in a triglyceride composition may be determined using the method AOCS Ce 5b-89 (revised 2017).

“SatSatO” is used to denote the sum of all isomers of asymmetric monounsaturated triglycerides (i.e. SatSatO, OSatSat) with the unsaturated fatty acid, i.e. oleic acid, in the 1- or 3-position. Similarly, “SatOSat” is used to denote the sum of all isomers of symmetric monounsaturated triglycerides with the unsaturated fatty acid, most often oleic acid, in the 2-position (but C18:2 would also work), and saturated fatty acids in the 1- and 3-position.

In the embodiments where one may like to determine the individual positional isomers, such as SatOSat or SatSatO, were determined by High Performance Liquid Chromatography (HPLC) in combination with an Evaporative Light Scattering Detector (ELSD). The sample preparation consists of an epoxidation of the double bonds of unsaturated fatty acids. This method is known, and suitable methods are available at commercial laboratories, such as Reading Scientific Services Ltd. and Mylnefield Lipid Analysis.

A “chocolate product” contains vegetable fats other than cocoa butter in a total amount of up to 5% by weight of the product. A “chocolate-like product” contains vegetable fats other than cocoa butter in a total amount of more than 5% by weight of the product.

“Vegetable fat compositions” are composed of one or more fats, or fractions thereof, which are derived from plants, such as from the seeds or flesh of a fruit.

“Cocoa butter” is the fat that is released from roasted cocoa beans on pressing. “Raw cocoa butter” is cocoa butter that has not been refined, i.e. subjected to harsh processing conditions such as high temperatures or reactive or catalytic environments, which may significantly modify its composition.

“Cocoa butter equivalents” are well-known in the art as edible fats, typically made up of one of more vegetable fats, having a composition and properties that are similar to cocoa butter, and that are compatible with cocoa butter and that have no significant effect on the behaviour of a chocolate in which they are used.

A “bloom-retarding” additive, when used in a chocolate or chocolate-like product, prevents, reduces or delays the formation of fat bloom on the product as compared to a product containing the cocoa butter from which the bloom retarding additive is derived, i.e. the cocoa butter before it is subjected to the method of the present invention.

### Bloom-Retarding Additive

The present invention provides a bloom-retarding additive which may be used in a chocolate or chocolate-like product. The bloom-retarding additive is a modified vegetable fat composition. In other words, the additive is a triglyceride composition derived from a vegetable fat composition, such as from a vegetable fat composition as described below.

The bloom-retarding additive comprises:
SatOSat in an amount of at least 55% by weight,
SatSatO in an amount of at least 2.8% by weight, and
a ratio by weight of SatSatO/Sat₃≥1.5, preferably >1.6, and more preferably >1.7.

The SatOSat content of the present invention is at least 55% by weight, for example 55-85% by weight, or 65-75% by weight. Increasing amount of SatOSat will make the chocolate or chocolate-like product harder.

Particularly important symmetric triglycerides are POP, SOS and POS. In particular, POS may be present in the bloom-retarding additive in an amount of less than 30% by weight of the bloom-retarding additive. More preferably, POS may be present in an amount of less than 25% by weight, such as less than 20% by weight of the bloom-retarding additive. Even more preferably, POS may be present in the bloom-retarding additive in an amount of less than 15% by weight of the bloom-retarding additive. SOS may be present in amount of greater than 5% by weight of the bloom-retarding additive. More preferably, SOS may be present in an amount of greater than 10% by weight, such as greater than 15% by weight, and greater than 20% by weight of the bloom-retarding additive. Even more preferably SOS may be present in an amount of greater than 25% by weight, 30% by weight, 35% by weight, 40% by weight, 45% by weight, 50% by weight and even greater than 55% by weight of bloom-retarding additive.

Thus, the bloom retarding additive may comprise, for example:
SatOSat in an amount of at least 55% by weight,
SatSatO in an amount of at least 2.8% by weight,
a ratio by weight of SatSatO/Sat₃≥1.5, preferably >1.6, and more preferably >1.7, and
wherein POS is present in an amount of less than 30% by weight by weight of bloom-retarding additive and SOS is present in an amount of greater than 5% by weight by weight of bloom-retarding additive.

The additive may comprise triunsaturated triglycerides (U₃) in an amount by weight which is higher than that of the vegetable fat composition from which it is derived, for instance higher by at least 0.1%, for example at least 0.2%, or at least 0.3%. It will be appreciated that “higher” in this context—in relation to U₃ but also other components of the additive composition—means the change in % content by weight, and not a % uplift on the original weight value. For instance, if the bloom-retarding additive contains U₃ in an amount of 1.5% by weight and the vegetable fat composition from which the additive is derived contains U₃ in an amount of 0.5% by weight, then the additive contains U₃ in an amount by weight which is higher by 1% than that of the vegetable fat composition. The additive may comprise U₃ in an amount of at least 1%, for example at least 1.2%, or at least 1.4% by weight.

The additive may comprise diunsaturated triglycerides (SatU₂) in an amount by weight which is higher than that of the vegetable fat composition from which it is derived, for instance higher by at least 5%, for example at least 7%, or at least 10%. The additive may comprise SatU₂ in an amount of at least 10%, for example at least 12%, or at least 15% by weight.

The additive may comprise monounsaturated triglycerides (Sat₂U) in an amount by weight which is lower than that of the vegetable fat composition from which it is derived, for instance lower by at least 5%, for example at least 7%, or at least 10%. The additive may comprise Sat₂U in an amount of up to than 85%, for example up to 83%, or up to 80% by weight.

The additive may comprise saturated triglycerides (Sat₃) in an amount by weight which is higher than that of the vegetable fat composition from which it is derived, for instance higher by at least 0.2%, for example at least 0.3%, or at least 0.5%. As mentioned previously, a higher content of Sat₃ in a triglyceride composition is generally thought to confer disadvantageous handling properties to a chocolate or chocolate-like product in which it used. Although the method of the present invention does increase the content of Sat₃ in the resultant bloom retarding additive, this is generally by less than that observed in additives which are prepared using prior art methods. Thus, the additive may comprise saturated triglycerides (Sat₃) in an amount which is higher than that of the vegetable fat composition from which it is derived, but only higher by up to 2%, and for example up to 1.5%. The additive may comprise Sat₃ in an amount of at least than 2%, for example at least 2.2%, or at least 2.5% by weight.

An advantage of the present invention is that the content of asymmetric monounsaturated fats (SatSatO) in the additive is relatively high thereby, at least in part, offsetting the detrimental properties of Sat₃. The additive may comprise SatSatO in an amount by weight which is higher than that of the vegetable fat composition from which it is derived, for instance higher by at least 2%, for example at least 2.5%, or at least 3%. The additive may comprise SatSatO in an amount of at least 3.5%, for example at least 4%, or at least 4.5% by weight.

The additive may comprise symmetric monounsaturated fats (SatOSat) in an amount by weight which is 10-22% lower than that of the vegetable fat composition from which it is derived, for instance 12-20 or 14-19% lower. The additive may comprise SatOSat in an amount of at least 55% by weight, for example 55-85% by weight, or 65-75% by weight.

The amounts of Sat₃ and SatSatO in the bloom-retarding additives of the present invention mean that the additive contains a desirable ratio by weight of SatSatO, i.e. asymmetric monounsaturated fats, to Sat₃ (i.e. SatSatO/Sat₃). The ratio by weight in the additive of SatSatO to Sat₃ may be higher than that of the vegetable fat composition from which it is derived, for instance by at least 0.5, for example at least 0.7, or at least 1.0. The ratio by weight in the additive is ≥1.5, preferably >1.6, and more preferably >1.7.

### Method for Preparing a Bloom-Retarding Additive

The present invention also provides a method for preparing a bloom-retarding additive for a chocolate or chocolate-like product, such as a bloom-retarding additive of the present invention.

In step a) of the method, a reaction mixture is provided which comprises a vegetable fat composition and free fatty acids. The reaction mixture may be provided by adding free fatty acids to a vegetable fat composition to form the reaction mixture.

The vegetable fat composition that is used in step a) is not particularly limited. However, in preferred embodiments, the vegetable fat composition is selected from shea oil, palm oil, illipe oil, mango oil, sal oil, kokum oil, cocoa butter and fractions and mixtures thereof. Particularly preferred is a vegetable fat composition that is a mixture that comprises, and preferably consists, of shea stearin and palm mid fraction. The mixture of shea stearin and palm mid fraction may contain at least 20%, for example at least 25%, or at least 30% by weight of each of shea stearin and palm mid fraction.

Preferably, the vegetable fat composition that is used in step a) is not a cocoa butter, and more preferably does not comprise cocoa butter (or fractions thereof). In preferred embodiments, the vegetable fat composition is a cocoa butter equivalent.

The vegetable fat compositions that are used in step a) typically comprise relatively high amounts of monounsaturated triglycerides (Sat₂U). For instance, the vegetable fat composition may contain Sat₂U in an amount of at least 80%, for example at least 85%, or at least 87% by weight.

The majority of the monounsaturated triglycerides in the vegetable fat composition are preferably symmetric in nature. Thus, the vegetable fat composition used in step a) may comprise SatOSat in an amount of at least 60%, for example at least 65%, or at least 70% by weight. These vegetable fat compositions are believed to be preferred for preparing additives having a ratio by weight of SatSatO/Sat₃≥1.5, preferably >1.6, and more preferably >1.7, particularly where free fatty acids are used in step a) in an amount of at least 5% by combined weight of free fatty acids and vegetable fat composition.

Particularly important symmetric triglycerides are POP, SOS and POS. In some embodiments, the vegetable fat composition used in step a) may comprises POP, SOS and POS in a combined about of at least 60%, preferably at least 65%, and more preferably at least 70% by weight.

In particular, POS may be present in an amount of less than 30% by weight of the vegetable fat composition. More preferably, POS may be present in an amount of less than 25% by weight, such as less than 20% by weight of the vegetable fat composition. Even more preferably, POS may be present in an amount of less than 15% by weight of the vegetable fat composition. SOS may be present in amount of greater than 5% by weight of the vegetable fat composition. More preferably, SOS may be present in an amount of greater than 10% by weight, such as greater than 15% by weight, 20% by weight, and greater than 25% by weight of the vegetable fat composition. Even more preferably SOS may be present in an amount of greater than 30% by weight, 35% by weight, 40% by weight, 45% by weight, 50% by weight, 55% by weight and even greater than 60% by weight of the vegetable fat composition.

Compositions which comprise substantial amounts of symmetric monounsaturated triglycerides like POP, SOS and POS, such as cocoa butter and the vegetable fat compositions used in method of the present invention, are not normally subjected to high temperatures for a long time (e.g. deodorised), because even minor changes in the triglyceride composition can compromise the properties, such as melting profile, of a chocolate or chocolate-like product in which the composition is used. It is therefore surprising that a vegetable fat composition may be treated using a method of the present invention, yet yields an additive which prevents bloom and at the same time maintains processability of a chocolate or chocolate-like product in which the additive is used.

The free fatty acids that are added to the vegetable fat composition in step a) of the method may be selected from oleic acid, stearic acid, palmitic acid and combinations thereof. These fatty acids are preferred because they correspond to those typically found in the triglycerides in cocoa butter. Though less preferred, other fatty acids may also be used in the method such as C8 to C22 fatty acids.

The free fatty acids that are added to the vegetable fat composition comprise unsaturated fatty acids. For instance, the free fatty acids may comprise unsaturated fatty acids in an amount of at least 10%, preferably at least 20%, and more preferably at least 30% by weight of the fatty acids. Where a mixture of saturated and unsaturated fatty acids is used, the free fatty acids preferably comprise saturated fatty acids in an amount of at least 10%, preferably at least 20%, and more preferably at least 30% by weight.

The free fatty acids may be added to the vegetable fat composition in an amount of at least 1%, preferably at least 3%, and more preferably at least 10% by combined weight of free fatty acids and vegetable fat composition. The free fatty acids may be added to the vegetable fat composition in an amount of up to 35%, preferably up to 25%, and more preferably up to 22% by combined weight of free fatty acids and vegetable fat composition. Thus, the free fatty acids may be added to the vegetable fat composition in an amount of from 1 to 35%, preferably from 3 to 25%, and more preferably from 10 to 22% by combined weight of free fatty acids and vegetable fat composition.

One of the advantages of the present invention is that the method may be carried out successfully without requiring a catalyst and/or a solvent. Indeed, in some embodiments, the reaction mixture contains the free fatty acids and vegetable fat composition in an amount of greater than 90% by weight, preferably greater than 95% by weight, and more preferably greater than 99% by weight. Particularly preferred is a reaction mixture which consists of the free fatty acids and vegetable fat composition.

Once the reaction mixture containing the free fatty acids and vegetable fat composition has been prepared, the additive may be formed in step b) of the method.

In step b), the reaction mixture is heated to a temperature of at least 190° C., preferably at least 200° C., and more preferably at least 210° C. The reaction mixture may be heated to a temperature of up to 240° C., preferably up to 235° C., and more preferably up to 230° C. Thus, the reaction mixture may be heated to a temperature of from 190 to 240° C., preferably from 200 to 235° C., and more preferably from 210 to 230° C. Particularly preferred is a temperature of from 210 to 220° C.

This temperature is maintained for a period of at least 4 hours. The temperature may be maintained for a period of at least 6 hours, preferably at least 8 hours, and more preferably at least 10 hours. The temperature may be maintained for a period of up to 20 hours, preferably up to 18 hours, and more preferably up to 16 hours. Thus, the temperature may be maintained for a period of from 6 to 20 hours, preferably from 8 to 18 hours, and more preferably from 10 to 16 hours.

The step of forming the additive is preferably carried out under vacuum to accelerate evaporation of water and thereby shift the reaction towards triglycerides instead of diglycerides. The skilled person will know the pressure to apply for generation the vacuum.

The skilled person will, of course, appreciate that the progress of the reaction is influenced by the reaction conditions and composition of the reaction mixture. For instance, the reaction will generally progress more quickly when higher temperatures are used.

Step b) will typically be carried out in a sealed vessel, i.e. a vessel from which no material is lost and to which no material is added during the reaction, as this prevents free fatty acids from leaving the reaction mixture. However, other methods for retaining the free fatty acids in the reaction mixture may also be used, such as by using a reflux condenser which returns vapours to the reaction mixture.

Once the reaction in step b) is complete, the reaction mixture will contain the bloom-retarding additive and free fatty acids. The free fatty acids are preferably separated from the additive in step c), e.g. by distillation or any other suitable method.

Preferably, the reaction mixture that is present at the end of step b) is used directly in the subsequent separation step. In other words, the reaction mixture at the end of step b) is not subjected to further processing that might change its composition, such as the addition and/or withdrawal of components from the reaction mixture. The reaction mixture may optionally be filtered, and the free fatty acids are separated from the additive by distillation (stripping), typical to an amount of <2% by weight free fatty acids in the mixture, and finally the mixture is deodorized. The skilled person will know how to perform the distillation and deodorization step.

Where separation step c) is carried out by distillation, distillation of the free fatty acids may be carried out at a temperature of at least 180° C., preferably at least 200° C., and more preferably at least 220° C. Distillation may be carried out at a temperature of up to 270° C., preferably up to 260° C., and more preferably up to 250° C. Thus, distillation may be carried out at a temperature of from 180 to 270° C., preferably from 200 to 260° C., and more preferably from 220 to 250° C.

Distillation may be carried out for a period of a few minutes to a couple of hours, depending on the composition of the additive, the pressure, and the temperature.

Distillation may be carried out under vacuum. Where a vacuum is not used, the reaction is preferably carried out under an inert atmosphere, such as a nitrogen or argon atmosphere. Where a vacuum is used, the reaction may also be carried out under an inert atmosphere, such as those described previously.

The skilled person will know the duration of the distillation by the circumstances.

Suitable distillation conditions include a temperature of 240° C. and reduced pressure, but other conditions may be used. It is generally preferred that the distillation conditions are applied only until the free fatty acids have been removed to avoid any significant further changes to the composition of the bloom-retarding additive.

It will be appreciated that, unlike reaction step b), separation step c) will not typically be carried out in a sealed vessel from the vessel but rather a vessel with an outlet through which the fatty acids may be withdrawn.

In some embodiments, the bloom-retarding additive may be further processed before it is used in a chocolate or chocolate-like product. For instance, the additive may be fractionated using, for example, dry or solvent fractionation processes.

However, in preferred embodiments, the bloom-retarding additive that is prepared in step b) is, aside from the preferred separation of the free fatty acids in step c), used directly in a chocolate or chocolate-like product. Thus, an advantage of the present invention is that the additive does not need to be subjected to further processing steps, such as fractionation or the like. This is unlike prior art methods in which e.g. fractionation steps are often required to reduce the contents of certain components such as saturated triglycerides (Sat₃).

### Ingredient for a Chocolate or Chocolate-Like Product

The bloom-retarding additive of the present invention may be used in a number of different ways. For instance, the additive may be used in cocoa butter or a cocoa butter equivalent to give an ingredient for a chocolate or chocolate-like product.

An ingredient for a chocolate or chocolate-like product of the present invention comprises a bloom-retarding additive of the present invention and cocoa butter or a cocoa butter equivalent. Though less preferred, a combination of cocoa butter and a cocoa butter equivalent may also be used in the ingredient.

In some embodiments, the ingredient may comprise cocoa butter. Any cocoa butter, i.e. any cocoa butter that is not processed in accordance with the method of the present invention, may be used with the bloom-retarding additive. For instance, the cocoa butter may be one that is processed using prior art methods, for instance it may be deodorised, or the cocoa butter may be a raw cocoa butter.

When the additive is used with a cocoa butter equivalent, suitable cocoa butter equivalents for inclusion in the ingredient for a chocolate or chocolate-like product include shea oil, palm oil, illipe oil, mango oil, sal oil, kokum oil and fractions and mixtures thereof. It will be appreciated that a combination of cocoa butter equivalents may also be used.

The ingredient for a chocolate or chocolate-like product may comprise the bloom-retarding additive in an amount of at least 20%, preferably at least 35%, and more preferably at least 50% by weight of the ingredient. The ingredient for a chocolate or chocolate-like product may comprise the bloom-retarding additive in an amount of up to 99%, preferably up to 97%, and more preferably up to 95% by weight of the ingredient. Thus, ingredient for a chocolate or chocolate-like product may comprise the bloom-retarding additive in an amount of from 20 to 99%, preferably 35 to 97%, and more preferably 50 to 95% by weight of the ingredient. It will be appreciated that, where more than one bloom-retarding additive of the present invention is used, these amounts refer to the total amount of bloom-retarding additive in the ingredient.

The ingredient for a chocolate or chocolate-like product may comprise the cocoa butter or cocoa butter equivalent in an amount of at least 40%, preferably at least 50%, and more preferably at least 60% by weight of the ingredient. It will be appreciated that, where a combination of cocoa butters, or a combination of cocoa butter equivalents, or a combination of cocoa butter and cocoa butter equivalent is used, these amounts refer to the total amount of cocoa butter and cocoa butter equivalent in the ingredient. In some instances, the ingredient for a chocolate or chocolate-like product consists of the bloom-retarding additive and the cocoa butter or cocoa butter equivalent and, as such, the cocoa butter or cocoa butter equivalent makes up the balance of the ingredient.

The ingredient for a chocolate or chocolate-like product may be prepared by a method which comprises blending the bloom-retarding additive of the present invention with cocoa butter or a cocoa butter equivalent. Blending may be carried out using conventional methods, e.g. in a mixer.

In some embodiments, the method further comprises preparing the bloom-retarding additive using a method described herein.

### Chocolate and Chocolate-Like Products

Another application of the bloom-retarding additive is in a chocolate or chocolate-like product. The ingredient for a chocolate or chocolate-like product of the present invention may also be used in a chocolate or chocolate-like product.

A chocolate or chocolate-like product of the present invention comprises a bloom-retarding additive or an ingredient for a chocolate or chocolate-like product (which itself comprises the bloom-retarding additive) of the present invention, and one or more further edible ingredients. Preferably, the product is a chocolate-like product.

Typical edible ingredients that may be used in the chocolate or chocolate-like product include at least one of cocoa solids, sugar and milk powder. For instance, where the product is a dark chocolate, the one or more further ingredients will typically include sugar and cocoa solids but not milk powder. Where the product is a milk chocolate, the one or more further ingredients will typically include sugar, cocoa solids and milk powder. Where the product is a white chocolate, the one or more further ingredients will typically include sugar and milk powder but not cocoa solids.

The chocolate or chocolate-like product may also comprise at least one of cocoa butter or a vegetable fat (i.e. other than cocoa butter) in addition to the bloom-retarding additive or ingredient for a chocolate or chocolate-like product of the present invention. Where the bloom-retarding additive is used in its additive form, i.e. not as part of an ingredient for a chocolate or chocolate-like product, then the chocolate or chocolate-like product will typically comprise at least one of cocoa butter or vegetable fat. Preferably, vegetable fat is used. Suitable vegetable fats include the cocoa butter equivalents listed above in connection with the ingredient for a chocolate or chocolate-like product.

One or more of a wide range of other ingredients and flavourings may also be used in the chocolate or chocolate-like product. A very typical flavouring is vanilla. Other flavourings include coffee, chilli, nuts, fruit (e.g. dried fruit such as raisins, sultanas and cherries), salt, pepper, flavoured oils (e.g. rose, orange and peppermint), caramel, alcohols (e.g. rum) or the like

The chocolate or chocolate-like product may also comprise additives to enhance its properties, such as an emulsifier. Typical emulsifiers include lecithin (e.g. soy lecithin), though other emulsifiers may also be used.

Advantageously, the bloom-retarding property of the additive of the present invention allows the chocolate or chocolate-like product to be, in its preferred form, otherwise free from bloom-retarding additives, in particular from conventional bloom-retarding additives such as interesterified fats, sorbitan triestearate, or milk fat.

The chocolate or chocolate-like product may comprise the bloom-retarding additive in an amount of at least 1%, preferably at least 2%, and more preferably at least 3% by weight of the product. The chocolate or chocolate-like product may comprise the bloom-retarding additive in an amount of up to 25%, preferably up to 20%, and more preferably up to 15% by weight of the product. Thus, the chocolate or chocolate-like product may comprise the bloom-retarding additive in an amount of from 1 to 25%, preferably from 2 to 20%, and more preferably from 3 to 15% by weight of the product. As mentioned above, the bloom-retarding additive may be included in the chocolate or chocolate-like product as part of an ingredient for a chocolate or chocolate-like product. It will be appreciated that, where more than one bloom-retarding additive of the present invention is used, these amounts refer to the total amount of bloom-retarding additive in the chocolate or chocolate-like product.

The chocolate or chocolate-like product may be prepared by a method which comprises blending a bloom-retarding additive or an ingredient for a chocolate or chocolate-like product of the present invention with the one or more further edible ingredients.

The method may further comprise conching the blended ingredients. Conching is a well-known process which provides chocolate and chocolate-like products with a smoother, less grainy, texture.

The method may further comprise tempering the blended, and typically conched, ingredients. Tempering is a well-known process to promote the formation of a target crystalline form, thereby enhancing the stability of the chocolate or chocolate-like product, its glossy appearance and ‘snap’ when broken. Preferably, the chocolate or chocolate-like product is tempered so that the fats that are present therein are present in a crystalline form. Where cocoa butter is present, particularly preferred is for chocolate of chocolate-like product to be tempered so that the cocoa butter that is present therein is present in crystalline Form V.

The method may further comprise moulding the chocolate or chocolate-like product, for instance by pouring the tempered chocolate or chocolate-like product into a mould and allowing the product to set.

In some embodiments, the method further comprises preparing bloom-retarding additive using a method as described herein. Additionally or alternatively, the method may comprise preparing the ingredient for a chocolate or chocolate-like product using a method as described herein.

### Properties and Uses

The bloom-retarding additive of the present invention may be used to confer advantageous properties onto ingredients and products in which the additive is used.

For instance, the bloom-retarding additive or ingredient for a chocolate or chocolate-like product of the present invention, which comprises the bloom-retarding components, may be used as a bloom-retarding component in a chocolate or chocolate-like product. Similarly, the bloom-retarding additive of the present invention may be used for enhancing the bloom-retarding properties of cocoa butter or a cocoa-butter equivalent.

In preferred embodiments, the bloom-retarding additive or ingredient prevents the formation of visible fat bloom on a chocolate or chocolate-like product. For instance, visible fat bloom may be prevented for a period of at least 10 weeks, preferably at least 15 weeks, and more preferably at least 20 weeks, when stored at 25° C. Fat bloom is considered visible when a trained expert considers that it has reached a level of grey at which the product is unacceptable for consumers.

The bloom-retarding additive or the ingredient for a chocolate or chocolate-like product of the present invention may be used for retarding bloom while maintaining the processability of a chocolate or chocolate-like product.

The following non-limiting examples further illustrate the present invention.

### EXAMPLES

In these examples, the amounts of U₃, SatU₂, Sat₂U and Sat₃, POP, POS and SOS in the different compositions were determined using method AOCS Ce 5b-89 (revised 2017). In these examples, the amounts of the individual positional isomers, such as SatOSat or SatSatO, were determined by High Performance Liquid Chromatography (HPLC) in combination with an Evaporative Light Scattering Detector (ELSD). The sample preparation consists of an epoxidation of the double bonds of unsaturated fatty acids. This method is known, and suitable methods are available at commercial laboratories, such as Reading Scientific Services Ltd. and Mylnefield Lipid Analysis.

### Example 1: Preparation of Triglyceride Additive Compositions From Vegetable Fat Compositions and Fatty Acids

A reaction mixture containing a vegetable fat composition and free fatty acids was prepared and processed according to a method of the present invention to produce triglyceride additive compositions. Palm mid-fraction having an IV of 33 and shea stearin having an IV of 36 were used in the vegetable fat composition, oleic acid and stearic acid were used as the free fatty acid.

To prepare the reaction mixture, the vegetable fats and free fatty acids were mixed in a reaction vessel. The reaction vessel was equipped with a vacuum inlet, a cold trap and a stirring device. The reaction mixture was then heated to 150° C. over approximately 20 minutes under a reduced pressure of 200mbar. The temperature was gradually raised to the process temperature and the pressure was gradually lowered to 33mbar over a period of from 30 to 60 minutes. Once the process temperature was reached, the reaction mixture was left at these conditions for either 6 or 11 or hours. The oil that was obtained in the process was then distilled at 240° C. under reduced pressure to remove the excess free fatty acids from the triglyceride additive composition.

The starting materials, reaction conditions, and composition of the triglyceride additive compositions before and after reaction are shown in the following table.

TABLE 1
Additive compositions I-IV.

| | | Additive composition | | | |
|---|---|---|---|---|---|
| | | I | II | III | IV |
| Starting | Fatty acids: stearic acid | 0 | 0 | 10.0 | 0 |
| material | oleic acid | 20.0 | 20.0 | 10.0 | 20.0 |
| (% by weight) | Fats: palm mid-fraction | 43.2 | 0 | 0 | 36.0 |
| | shea stearin | 36.8 | 80.0 | 80.0 | 44.0 |
| Reaction | Process temperature (° C.) | 210 | 220 | 220 | 220 |
| conditions | Process time (hours) | 11 | 11 | 11 | 6 |
| | | IA | IIA | IIIA | IVA |
| Starting | U₃ | 1.0 | 1.1 | 1.1 | 0.9 |
| material | SatU₂ | 5.8 | 8.1 | 8.1 | 7.4 |
| TAG | Sat₂U | 90.7 | 89.1 | 89.1 | 89.2 |
| composition | Sat₃ | 2.5 | 1.7 | 1.7 | 2.5 |
| (denoted | POP | 35.5 | 0.5 | 0.5 | 35.5 |
| IA-IIIA) | POS | 11.3 | 7.6 | 7.6 | 11.3 |
| | SOS | 32.5 | 68.0 | 68.0 | 32.5 |
| | SatSatO | 2.7 | 0.5 | 0.5 | 2.7 |
| | Ratio: SatSatO/Sat₃ | 1.08 | 0.29 | 0.29 | 1.08 |
| | | IB | IIB | IIIB | IVB |
| Additive | U₃ | 1.6 | 2.5 | 1.4 | 1.5 |
| product | SatU₂ | 16.5 | 23.6 | 15.7 | 18.0 |
| TAG | Sat₂U | 78.5 | 71.7 | 79.4 | 77.3 |
| composition | Sat₃ | 3.4 | 2.2 | 3.5 | 3.2 |
| (denoted | POP | 29.9 | 0.5 | 0.4 | 30.9 |
| IB-IIIB) | POS | 11.0 | 6.6 | 6.9 | 10.9 |
| | SOS | 26.9 | 54.5 | 60.5 | 26.7 |
| | SatSatO | 7.9 | 4.8 | 6.2 | 6.0 |
| | Ratio: SatSatO/Sat₃ | 2.32 | 2.18 | 1.77 | 1.88 |

Surprisingly, it can be seen that the triglyceride additive compositions produced by a method of the present invention each have a ratio of SatSatO to Sat₃ which is significantly higher than 1.7. These ratios are not a result of random interesterification which would give a ratio of approximately 1.25. Surprisingly, the high ratio is still achieved even when a mixture of saturated and unsaturated free fatty acids, instead of just oleic acid, is used (see additive composition III). In contrast, the untreated vegetable fat compositions have a ratio of SatSatO to Sat₃ of 1.08 at most.

Advantageously, a lowering of the amount of diglycerides in the composition was also observed as a result of carrying out the method of the present invention.

### Example 2: Preparation of Chocolate Bars Containing a Triglyceride Additive Composition Prepared From a Vegetable Fat Composition and Fatty Acid

The triglyceride additive composition IB that was prepared in Example 1 was incorporated into a chocolate bar in order to test its bloom-preventing properties.

A basic batch of dark chocolate was prepared from the following ingredients: 52.16% sugar, 42.10% cocoa mass, 5.30% pure prime press cocoa butter and 0.44% lecithin, by weight. All of the ingredients except lecithin and a part of the fat were blended in a stainless-steel chocolate mélangeur to a plastic consistency which is able to be refined on a 700 mm Lehmann refiner to an average particle size of 20 microns. The refined mass was dry conched for 6 hours in a 50 kg Baurmeister Conch. The remaining part of the fat was added and the mixture conched for a further 6 hours. The lecithin was added 30 minutes before end of conching. The resulting dark chocolate had a fat content of 28.9% by weight.

The dark basic batch of dark chocolate was blended with additive composition IB from Example 1 then formed into a chocolate bar. The chocolate bar was prepared by mixing all ingredients to a homogeneous chocolate on a Teddy mixer with a water jacket at 60° C. for 2 hours.

The composition of the chocolate bar is shown in the following table. For reference, a chocolate bar containing only a corresponding untreated vegetable fat composition, i.e. additive composition IA, was also prepared.

TABLE 2
Chocolate bars comprising additive composition.

| | Chocolate bar | |
|---|---|---|
| | B | C |
| Dark chocolate basic batch | 90 | 90 |
| Additive composition IA | 5.5 | 0 |
| Additive composition IB | 0 | 5.5 |
| Pure prime press cocoa butter | 4.5 | 4.5 |
| Total fat content | 36.0 | 36.0 |
| ΣSat₃ | 1.8 | 1.9 |
| ΣSatSatO | 0.4 | 1.2 |

It can be seen that the triglyceride additive compositions of the present invention increased the concentration of Sat₃ in the final chocolate product (see Chocolates C) only slightly more than the corresponding untreated vegetable fat composition (see Chocolate B). Thus, the triglyceride additive compositions of the present invention are not expected to significantly enhance the viscosity of a chocolate or chocolate-like product in which they are used.

### Example 3: Bloom-Retarding Performance of a Triglyceride Additive Composition Prepared From a Vegetable Fat Composition and Fatty Acid

Experiments were conducted to determine whether the triglyceride additive compositions had any effect on the shelf-life of the chocolates prepared in Example 2.

Before use, the chocolates prepared in Example 2 were tempered optimally on an AMC 50 tempering machine. 50 g tablet bars were prepared from each chocolate and cooled for 30 minutes in a Morcos 3 zones cooling tunnel. The tablet bars were kept at 20° C. +/−0.5° C. for 1 week after production. The samples were then moved to different cabinets for shelf-life tests at different isothermal temperatures.

The bloom on the different chocolates were assessed by a panel without knowledge of the composition of the individual chocolates. Bloom begins as a faint dull and grey layer. Over time, this layer becomes increasingly visible until the chocolate bar is substantially covered in a grey/white layer. The panel decided the level of grey at which the product was unacceptable for consumers. The results of the test are shown in the following table, expressed in terms of the number of weeks from production to unacceptable greyness.

TABLE 3
Blooming of chocolate comprising additive composition.

| | | Chocolate | |
|---|---|---|---|
| | | B | C |
| Weeks to unacceptable | 20° C. | >20 | >20 |
| | 25° C. | 9 | >20 |

It can be seen that the triglyceride additive composition of the present invention significantly delayed the onset of visible bloom in a chocolate product (see Chocolates C) as compared to the corresponding untreated vegetable fat composition (see Chocolate B).

1. A bloom-retarding additive comprising a modified vegetable fat composition which comprises:
SatOSat in an amount of at least 55% by weight,
SatSatO in an amount of at least 2.8% by weight, and
a ratio by weight of SatSatO to Sat₃≥1.5.

2. The bloom-retarding additive of claim 1, wherein the additive further comprises:
U₃ in an amount of at least 0.5% by weight;
SatU₂ in an amount of at least 10% by weight;
Sat₂U in an amount of up to 85% by weight; and
Sat₃ in an amount of at least 2% by weight.

3. The bloom-retarding additive of claim 1, wherein the bloom-retarding additive comprises POS in an amount of less than 30% by weight of the bloom-retarding additive.

4. The bloom retarding additive of claim 3, wherein the bloom-retarding additive comprises POS in an amount of less than 15% by weight of the bloom-retarding additive.

5. The bloom retarding additive of claim 1, wherein the bloom-retarding additive comprises SOS in an amount of greater than 5% by weight of the bloom-retarding additive.

6. The bloom retarding additive of claim 5, wherein the bloom-retarding additive comprises SOS in an amount of greater than 25% by weight of the bloom-retarding additive.

7. The bloom-retarding additive of claim 1 comprising:
SatOSat in an amount of at least 55% by weight,
SatSatO in an amount of at least 2.8% by weight,
a ratio by weight of SatSatO to Sat₃≥1.5, and
wherein POS is present in an amount of less than 30% by weight of the bloom-retarding additive and SOS is present in an amount of greater than 5% by weight of the bloom-retarding additive.

8. A method for preparing a bloom-retarding additive for a chocolate or chocolate-like product, said method comprising:
a) providing a reaction mixture which comprises a vegetable fat composition and free fatty acids, wherein at least some of the free fatty acids are unsaturated; and
b) forming the additive by heating the reaction mixture to a temperature of at least 190° C. and maintaining the temperature for a period of at least 4 hours.

9. The method of claim 8, wherein the vegetable fat composition used in in step (a) comprises SatOSat in an amount of at least 60% by weight to give an additive having a ratio by weight of SatSatO/Sat₃≥1.5.

10. The method of claim 8, wherein the reaction mixture is heated to a temperature of from 190 to 240° C.

11. The method of claim 8, wherein the temperature is maintained for a period of from 6 to 20 hours.

12. The method of claim 8, wherein the step of forming the additive is carried out under vacuum.

13. The method of claim 8, wherein the reaction mixture comprises the free fatty acids in an amount of from 1 to 35% by combined weight of free fatty acids and vegetable fat composition.

14. The method of claim 8, wherein: the free fatty acids are selected from C8 to C22 fatty acids; and/or the free fatty acids comprise unsaturated fatty acids in an amount of at least 10% by weight of the free fatty acids.

15. The method of claim 8, wherein the method comprises the step of:
c) separating free fatty acids from the additive.

16. The method of claim 8, wherein the reaction mixture consists of free fatty acids and the vegetable fat composition.

17. The method of claim 8, wherein the vegetable fat composition is selected from shea oil, palm oil, illipe oil, mango oil, sal oil, kokum oil, cocoa butter and fractions and mixtures thereof.

18. A bloom-retarding additive which is produced by the method of claim 8.

19. A method of preparing an ingredient for a chocolate or chocolate-like product, said method comprising blending the bloom-retarding additive of claim 1 with cocoa butter and/or a cocoa butter equivalent.

20. An ingredient for a chocolate or chocolate-like product which is produced by the method of claim 19.

21. An ingredient for a chocolate or chocolate-like product which comprises the bloom-retarding additive of claim 1 and cocoa butter and/or a cocoa butter equivalent.

22. The ingredient for a chocolate or chocolate-like product of claim 21, wherein the additive is present in an amount of from 20 to 99% by weight of the ingredient.

23. A method of preparing a chocolate or chocolate-like product, said method comprising blending the bloom-retarding additive of claim 1 with one or more further edible ingredients.

24. A chocolate or chocolate-like product which is produced by the method of claim 23.

25. A chocolate or chocolate-like product which comprises the bloom-retarding additive of claim 1 and one or more further edible ingredients.

26. The chocolate or chocolate-like product of claim 25, wherein the additive is used in an amount of from 1 to 25% by weight of the product.

27. A method of making a chocolate or chocolate-like product, comprising addition of the ingredient for the chocolate or chocolate-like product of claim 20.

28. A method of making a chocolate or chocolate-like product, comprising addition of the ingredient for the chocolate or chocolate-like product of claim 20 as a bloom-retarding component in the chocolate or chocolate-like product.

29. A method of making a chocolate or chocolate-like product, comprising addition of the bloom-retarding additive of claim 1 for retarding bloom while maintaining the processability of the chocolate or chocolate-like product.

30. A method of making a cocoa butter or cocoa butter equivalent, comprising addition of the bloom-retarding additive of claim 1.

31. A method of making a cocoa butter or cocoa butter equivalent, comprising addition of the bloom-retarding additive of claim 1 for enhancing the bloom-retarding properties of the cocoa butter or the cocoa butter equivalent.
